(19) United States
(12) Patent Application Publication
(10) Pub. No.: US 2022/0380035 A1
(43) Pub. Date: Dec. 1, 2022

(54) METHODS OF VERTICAL TAKE-OFF/LANDING AND HORIZONTAL STRAIGHT FLIGHT OF AIRCRAFT AND AIRCRAFT FOR IMPLEMENTATION

(71) Applicant: HOVERSURF, INC., Washington, DE (US)

(72) Inventor: Aleksandr V. Atamanov, Saint Petersburg (RU)

(21) Appl. No.: 17/488,160

(22) Filed: Sep. 28, 2021

(30) Foreign Application Priority Data
Jun. 1, 2021 (RU) 2021115699

(51) Int. Cl. B64C 29/00; B64D 27/24; B64C 27/20; B64C 11/00; B64C 1/06

(52) U.S. Cl. CPC B64C 29/0025; B64D 27/24; B64C 27/20; B64C 11/00; B64C 1/061

(57) ABSTRACT

Vertical take-off, landing and horizontal straight flight of an aircraft includes activation a plurality of front and rear lifting in-ring propellers, each of which is connected to a respective independently operating electric motor. In addition, horizontal straight flight of the aircraft includes activation of additional left and right pushing propellers, each of which is connected to an independently operating electric motor. The front and rear lifting in-ring propellers are respectively positioned generally horizontally and symmetrically opposite to one another and equidistantly relative to a longitudinal axis of the aircraft. The right pushing propeller and the left pushing propeller are positioned generally vertically and symmetrically opposite to one another and equidistantly relative to the longitudinal axis of the aircraft.

### CROSS-REFERENCE TO RELATED APPLICATIONS

This Application Claims priority to Russian patent application no. 2021115699, filed Jun. 1, 2021.

### TECHNICAL FIELD

The group of inventions described herein relates to aviation technology, namely, to aircraft capable of vertical take-off/landing and horizontal straight flight.

### BACKGROUND

From the state of the art, the Multi-rotor Heavy Convento-rotorcraft is known (see Patent of the Russian Federation No. 2521121 for an invention, published on Jun. 27, 2014).

The Convento-rotorcraft is made in the form of the high-positioned monoplane, having rotors in rotary annular channels on the wing consoles, a fuselage with two power beams pivotally mounted in a diamond-shaped rocker plan, which has the possibility of deflecting its beams in the longitudinal plane and equipped with bearing rotors on pylons on its opposite tops. The rotors are connected by transmission shafts to the engines of the power plant mounted in the root part of the wing.

The Convento-rotorcraft has the tail unit with an all-movable stabilizer, the three-rack retractable wheel landing gear, the wing is made in the form of combination of two wings with the close location to each other, mounted by the ledge. The front wing is higher than the rear with the negative degradation of the first to the second in the angle of attack. The inter-gondola sections of the front and rear wings are equipped with the slat and flap and are mounted so that between the rear edge of the front wing and the front edge of the rear wing, which has 45% of the area of the front wing, there is a narrow gap equal to 2.5% of the chord of the front wing at the distance between the middle lines of the profile of the front and rear wings, equal to 30% of the chord of the rear wing.

The disadvantages of the known technical solution are: need to turn the movers; low handling and maneuverability; low safety of take-off, flight and landing of aircraft due to the lack of protection of the rotors from collisions with the ground surface and other obstacles; and large weight and size parameters (characteristics) of the aircraft.

From the state of the art, the method of flying in the air with the possibility of vertical take-off and landing is known (see Patent of the Russian Federation No. 2566177 for an invention, published on Oct. 20, 2015).

The flight method involves the creation of the air flow directed from top to bottom by coaxial movers with blades rotating in opposite directions. The blades have the ability to rotate around their longitudinal axis with the change of the angle of attack. By changing the rotation angles of the movers blades during each rotation, ensure the creation of the horizontal component of the thrust vector and the stabilization of the flight. Horizontal thrust in the steady-state horizontal flight mode is created by the jet mover. By turning the blades of the mover to the angle of attack of 0° in the mode of prolonged horizontal flight, the closed aerodynamic surface is formed—the rotating wing with the possibility of creating the climb power. The movers are connected to the engine through the gear drive system. The mover blades are connected to tilt system, gyroscope and control system.

The disadvantages of the known technical solution are: low reliability and controllability, since for horizontal flight there is one mover installed in the center; possibility of only horizontal straight flight; jet mover is used, which leads to the deterioration of maneuverability and environmental friendliness; low safety of take-off, flight and landing of the aircraft; and lack of protection of the rotors from collisions with the ground surface and other obstacles.

From the state of the art, the method of flight of aircraft and aircraft for its implementation are known (see International Publication of the Application WO2017198082 for an invention, published on May 8, 2017).

The disadvantages of the technical solution known from the state of the art are: need to change the horizontal position of the airframe for straight flight; need to use partially the thrust of the lifting movers to create the force pushing the aircraft forward; low safety of take-off, flight and landing of the aircraft; low flight speed; low flight comfort of the aircraft for passengers; low reliability.

An objective of the group of inventions described herein is to create a compact, safe aircraft during take-off/landing and flight with high maneuverability and controllability, as well as increased flight speed.

### SUMMARY

The technical results of the group of inventions described herein include:
reduction of energy costs for horizontal straight flight;
increased flight stability and comfort;
improved flight handling and maneuverability;
improving environmental friendliness;
reduced drag during horizontal straight flight;
increasing the thrust and flight speed of the aircraft;
increasing the safety of take-off, flight and landing of aircraft;
increased fail-safety while maintaining the position of the aircraft in flight;
ensuring the protection of the propellers from collisions with the ground surface and other obstacles during flight;
increasing the compactness of the aircraft (reducing the overall dimensions of the aircraft);
possibility to quickly identify and eliminate malfunctions (breakdowns) of electric motors and lifting bearing propellers (rotors);
possibility of both horizontal straight flight and vertical take-off/landing.

The technical results of the group of inventions described herein are achieved by the fact that the aircraft for vertical take-off/landing and horizontal straight flight contains:

a plurality of front lifting propellers and a plurality of rear lifting propellers configured to facilitate a vertical take-off or landing of the aircraft when activated, each of the front lifting propellers and the rear lifting propellers being an in-ring propeller that is mounted to a load-bearing carriage frame and is connected to a respective independently operating electric motor; wherein the front lifting propellers and the rear lifting propellers are present in equal numbers; wherein the front lifting propellers are positioned generally horizontally and symmetrically opposite to one another and equidistantly relative to the longitudinal axis of the aircraft; and wherein the rear lifting propellers are positioned generally horizontally and symmetrically opposite to one another and equidistantly relative to the longitudinal axis of the aircraft; and

at least one right pushing propeller and at least one left pushing propeller configured to facilitate a horizontal straight flight of the aircraft when activated, each of the at least one right pushing propeller and the at least one left pushing propeller being connected to a respective independently operating electric motor; wherein the at least one right pushing propeller and the at least one left pushing propeller are present in equal numbers; and wherein the at least one right pushing propeller and the at least one left pushing propeller are positioned generally vertically and symmetrically opposite to one another and equidistantly relative to the longitudinal axis of the aircraft.

In an embodiment, the right and left pushing propellers are positioned closer to a middle than to opposite ends of the at least one common load-bearing frame and closer to a rear of the aircraft than to a front of the aircraft.

In one embodiment, the right and left pushing propellers are positioned at a middle of the aircraft and on a right side and left side of the aircraft, respectively; and the right and left pushing propellers are positioned on left and right sides of the aircraft and rotate about a horizontal axis parallel to the longitudinal axis of the aircraft.

In an embodiment, the independently operating electric motors of the at least one right and left pushing propellers are coupled to at least one common load-bearing frame oriented perpendicularly to the longitudinal axis of the aircraft, and the right and left pushing in-ring propellers are located on right and left sides of the aircraft, respectively, and rotate about a horizontal axis parallel to the longitudinal axis of the aircraft.

In one embodiment, the independently operating electric motors of the front and rear in-ring lifting propellers are mounted on an external load-bearing carriage frame, and each of front lifting in-ring propellers and the rear lifting in-ring propellers rotates about a respective vertical axis.

In an embodiment, the independently operating electric motors of the right and left pushing propellers include a coaxial pair of the independently operating electric motors, and wherein the coaxial pair of the electric motors of the at least one right and left pushing propellers are mounted on at least one common load-bearing frame, and each of at least one right and left pushing propellers rotates about a respective horizontal axis and does not contact the external carriage frame during rotation about the respective horizontal axis.

In one embodiment, the independently operating electric motors of the front and rear lifting in-ring propellers include a plurality of coaxial independently operating electric motors, and the coaxial independently operating electric motors of the front and rear lifting in-ring propellers mounted to an inner surface of the external carriage frame, and each of at least one right and left pushing propellers rotates about a respective horizontal axis and does not contact the external carriage frame during rotation about the respective horizontal axis.

In one embodiment, the external carriage frame is tubular and in a form of a closed-end or open-end ellipsoid or parallelepiped

In an embodiment, the right and left pushing propellers are present in equal total numbers on right and left sides of the aircraft, respectively; and the independently operating electric motors of the at least one right pushing propeller and the at least one left pushing propeller are located interiorly relative to an external carriage frame such that the independently operating electric motors of the at least one right and left pushing propeller are visible and accessible from all sides of the aircraft.

In one embodiment, the front and rear independently operating electric motors of the front and rear lifting in-ring propellers are present in equal total numbers at a front and rear of the aircraft, respectively.

### BRIEF DESCRIPTION OF THE DRAWINGS

The features and essence of the group of inventions described herein are explained in the following detailed description, illustrated by drawings (see FIGS. 1-5), where the following is shown.

FIG. 1 shows a prior art aircraft with front and rear movers-propellers (rotors).

FIG. 2 shows an embodiment of an aircraft for vertical take-off/landing and horizontal straight flight with front and rear lifting in-ring propellers and additional auxiliary running (pushing) propellers;

FIG. 3 shows a side view of an embodiment of a rotor-motor group including a coaxial pair of electric motors associated with the right and left pushing propellers, placed and fixed within a generally ellipsoid load-bearing spatial tubular external carriage frame of a closed-end type.

FIG. 4 shows a side view of an embodiment of a rotor-motor group that includes three coaxial pairs of electric motors associated with the front and rear lifting propellers, placed and fixed on inside surfaces of the load-bearing spatial tubular ellipsoid external carriage frame of the closed -end type.

FIG. 5 shows a side view of an embodiment of the aircraft including three coaxial pairs of electric motors of lifting propellers (rotors), placed within an open bearing spatial tubular ellipsoid external carriage frame of the closed-end type and mounted on one inner supporting bearing power platform frame.

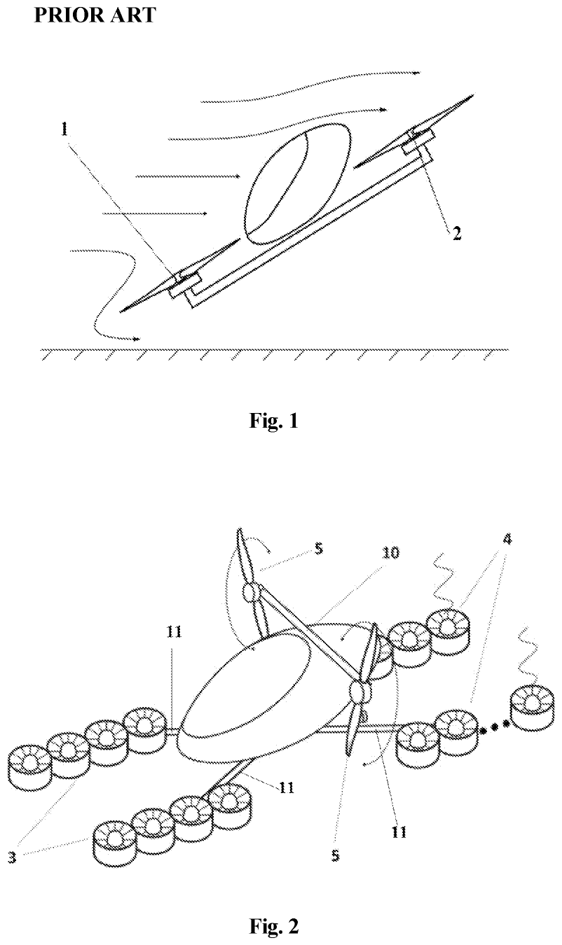

The reference numbers in FIGS. 1-5 indicate the following features of the exemplary embodiments:

1—front movers—main front lifting or carrying rotors or propellers;

2—rear movers—main front running or pushing rotors or propellers;

3—front group of lifting or carrying in-ring movers or propellers

4—rear group of lifting or carrying in-ring movers or propellers;

5—additional (auxiliary) running (pushing) right and left rotors or propellers;

6—load-bearing spatial (tubular) ellipsoid carriage frame of a closed type;

7—independently operating electric motors of a coaxial pair;

8—running (pushing) propellers (rotors) of a coaxial pair;

9—load-bearing power platform—frame located inside the tubular carriage frame;

10—load-bearing power platform—frame for installing running (pushing) right and left propellers;

11—load-bearing power platform—carriage frame for installing the front and rear lifting in-ring propellers (movers);

12—internal surfaces (parts) of tubes of the open bearing spatial carriage frame that are opposite and symmetrical of relative to each other;

13 upper tube of the open load-bearing spatial carriage frame of the lifting RMG;

14—lower tube of the open load-bearing spatial carriage frame of the lifting RMG.

### DETAILED DESCRIPTION

FIG. 2 shows an embodiment of a claimed aircraft with two groups of front lifting in-ring propellers (movers) 3 and two groups of rear lifting in-ring propellers (movers) 4, and two additional auxiliary pushing (running) propellers (rotors) 5, one pushing propeller (rotor) 5 on a left side of the aircraft and one pushing propeller (rotor) 6 on a right side of the aircraft.

Each group of front 3 and rear 4 lifting in-ring propellers includes four in-ring propellers installed on end sections of a pipe-like load-bearing power platform carriage frame 11.

The front and rear lifting in-ring propellers 3, 4 are installed in a generally horizontal plane at a certain distance from each other, while the blades of each lifting in-ring propeller 3, 4 rotate around their respective vertical axis.

The pushing (running) propellers (rotors) 5 are installed on right and left sides of the aircraft relative to the longitudinal axis of the aircraft and are mounted on one (see FIG. 2) or more common supporting frame 10 oriented generally perpendicularly to the longitudinal axis of the aircraft. For example, the pushing propellers 5 can be installed on two separate load-bearing pipe-like frames generally perpendicular to the longitudinal axis of the aircraft (not shown).

In the embodiment of FIG. 2, only the pushing propellers 5 are installed at the center of the aircraft. For example, the pushing propellers (rotors) 5 are installed at the center of the aircraft and on the right and left side of the aircraft, and are equidistant from the center of the aircraft.

The pushing (running) propellers (rotors) 5 are installed in a generally vertical plane perpendicular to the longitudinal axis of the aircraft, while each of the pushing propellers (rotors) 5 rotates around its respective horizontal axis.

In the embodiment of FIG. 2, the total number of installed front 3 and rear 4 lifting in-ring propellers is the identical and can be any number.

The total number of installed running (pushing) propellers (rotors) 5 can be any and is the same on each side of the aircraft.

FIG. 2 shows one of the embodiments of the aircraft. Other embodiments of the aircraft are also possible, for example, with four running (pushing) bearing propellers 5 (two on each side of the aircraft) and with four lifting in-ring propellers 3, 4 (two in-ring propellers at each of the front and the rear of the aircraft).

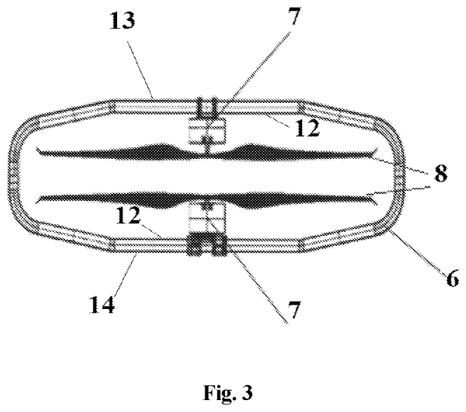

FIG. 3 shows an embodiment of the running (pushing) rotor-motor group (RMG) in a form of a single coaxial pair of electric motors 7 of the pushing propellers (rotors) 8, fixed inside the load-bearing spatial (tubular) frame 6 in a form of a closed-end type of ellipsoid.

Independently operating electric motors 7 of the running (pushing) propellers (rotors) 8 are fixed by their fixed base to the inner surfaces (parts) 12 of the tubes (front 13 and rear 14 in the direction of the aircraft movement in the horizontal plane) of the spatial frame 6, thus forming the RMG including one coaxial pair of electric motors 7 bearing propellers (rotors) 8.

Independently operating electric motors 7 of the pushing propellers (rotors) 8 are installed inside spatial tubular frame 6 in such a way that they are visible from all external sides and there is access to them. Each of the pushing propellers 8 is connected to an independently operating electric motor 7, respectively.

The RMG can be installed inside the frame 6 in the center (in the central part) of the aircraft and/or on the left and right of the aircraft. Independently operating electric motors 7 of the running (pushing) propellers (rotors) 8 are installed at the front 13 and rear 14, relative to the direction of movement of the aircraft or the load-bearing frame 10, internal, facing each other, opposite surfaces (parts) 12 of the tubes of the load-bearing spatial carriage frame 6, thus forming the rotor-motor group (RMG) consisting of one coaxial pair of electric motors 7 of the pushing propellers (rotors) 8, such that the pushing propellers (rotors) 8 of the coaxial pair rotate parallel to each other around a horizontal axis, are turned to each other, and do not touch the tubes of the load-bearing spatial carriage frame 6, with only air between the pushing propellers (rotors) 8 of the coaxial pair.

FIG. 3 shows one of the embodiments of the aircraft with one coaxial pair of electric motors 7 of the pushing propellers (rotors) 8 installed inside one load-bearing spatial (tubular) carriage frame 6. The number of coaxial pairs within the open spatial tubular carriage frame 6 can be any, depending on its size and volume.

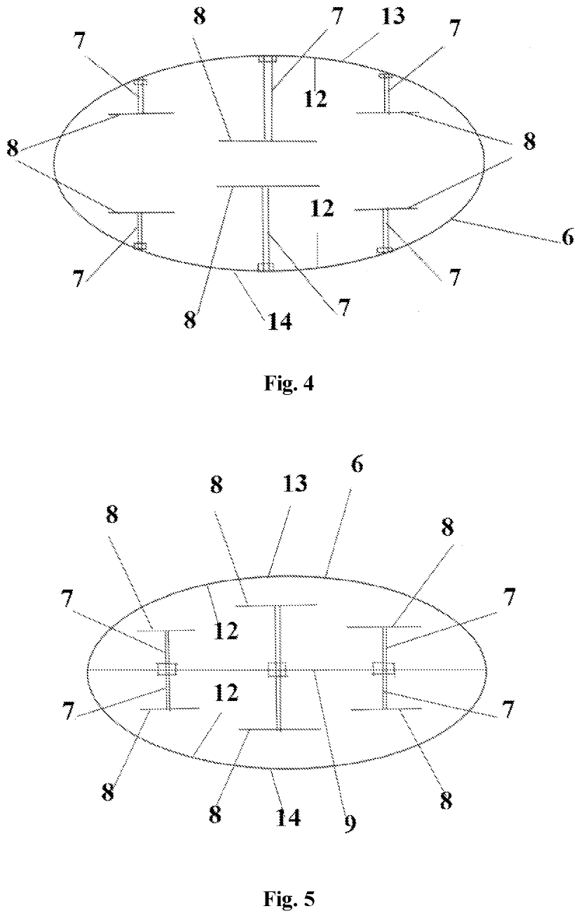

FIG. 4 shows an embodiment of the running (pushing) RMG of the aircraft in the form of the three coaxial pair of electric motors 7 of the pushing propellers (rotors) 8, fixed inside the open bearing spatial (tubular) carriage frame 6 in the form of ellipsoid (top view).

The RMG can be installed within the carriage frame 6 in the center and/or to the left and right of the side of the aircraft, independently operating electric motors 7 of the running (pushing) propellers (rotors) 8 are fixed with their fixed base on the front 13 and rear 14, relative to the direction of movement of the aircraft in the horizontal plane, internal opposite and symmetrical surfaces (parts) 12 of the tubes of the open bearing spatial carriage frame 6, thus forming the RMG including three coaxial pairs of electric motors 7 of the pushing propellers (rotors) 8, located at a certain distance from each other in the horizontal plane perpendicular to the longitudinal axis of the aircraft, while the pushing propellers (rotors) 8 of the coaxial pair rotate parallel to each other around a horizontal axis and are oriented toward each other, and do not touch the load-bearing carriage frame 6, with only air being between the pushing propellers (rotors) 8 of the coaxial pair.

In the embodiments where the electric motors 7 of the of attaching propellers (rotors) 8 are attached to the inner surfaces (parts) 12 of the carriage frame 6 shown in FIGS. 3 and 4, there is a gap of distance (from 5 cm) between the planes of the pushing propellers (rotors) 8 of the coaxial pair, resulting from the strength and flexibility of the structure, to exclude the possibility of collisions during vibration, hard landing, turns, and other. At the centers of the pushing propellers 8, on the sides facing each other, there are fixed Capralon™ cones protruding at a distance of 0.2 mm or more above the plane of the pushing propeller 8, but not touching each other. This makes it possible not to damage the pushing rotor blades 8 even in a critical situation, since any impact will be received by the cones.

FIG. 4 shows one of the embodiments of the aircraft with three coaxial pairs of electric motors 7 of pushing propellers (rotors) 8 installed within the load-bearing carriage frame 6 at a specified distance from each other. The number of coaxial pairs within the load-bearing carriage frame 6 can be any, depending on its size and volume.

The running (pushing) RMG shown in FIG. 4 can be installed at the center (in the central rear part) of the side of the aircraft (when using one pushing RMG on the aircraft) and/or at the left and right sides of the aircraft. In this case, the side RMGs are located on the left and right at the same distance from the central RMG and relative to each other.

FIG. 5 shows another embodiment of the running rotor-motor group (RMG) of the aircraft in the form of three coaxial pairs of electric motors 7 of pushing propellers (rotors) 8 fixed inside the load-bearing spatial (tubular) carriage frame 6 in the form of ellipsoid at the certain distance from each other (top view).

Independently operating electric motors 7 of the pushing propellers (rotors) 8 are fixed by their fixed base perpendicular to the front and rear, relative to the direction of movement of the aircraft in the horizontal plane, on the bearing power platform—frame 9 located in the central part (in the middle) inside the load bearing open spatial tubular ellipsoid carriage frame 6, oppositely and symmetrically relative to each other, thus forming the RMG, including three coaxial pairs of electric motors 7 of pushing propellers (rotors) 8, located at a certain distance from each other. In this case, the pushing propellers (rotors) 8 of the coaxial pair are turned toward the inner surfaces (parts) 12 of the front 13 and rear 14 tubes of the open spatial ellipsoid load bearing carriage frame 6 facing each other, opposite and symmetrical with relation to each other, and do not touch them, and the pushing propellers (rotors) 8 of the coaxial pair rotate parallel to each other around the horizontal axis and only air is located between the pushing propellers (rotors) 8 of the coaxial pair and the inner surfaces (parts) 12 of the tubes of the open spatial ellipsoid frame 6 that are opposite and symmetrical relative to each other.

When installing the RMG in the center and/or to the right and left sides of the aircraft, the running (pushing) propellers (rotors) 8 of the coaxial pair are turned to the front 13 and rear 14, relative to the longitudinal axis of the aircraft (or the load-bearing frame 10), internal, facing each other, opposite and symmetrical relative to each other surfaces (parts) 12 of the tubes (13, 14) of the open spatial ellipsoid load bearing carriage frame 6, the pushing propellers (rotors) 8 of the coaxial pair rotate parallel to each other around one horizontal axis.

FIG. 5 shows one of the embodiments of the running of RMG of the aircraft. The number of coaxial pairs inside one open spatial tubular carriage frame 6 can be any, depending on its size and volume.

The running (pushing) RMG shown in FIG. 5 can be installed at the center (in the central rear part) of the side of the aircraft (when using one pushing RMG on the aircraft) and/or at the left and right sides of the aircraft. In this case, the side RMGs are located at the certain equal distance from the central RMG.

The open load-bearing spatial (tubular) carriage frame (ref. no. 6 in FIG. 3, 4, 5) is the system (space truss) of interconnected tubes made of high-strength materials/metals, for example, aluminum alloy, and performs the function of the screen completely covering the electric motors 7 and the pushing propellers (rotors) 8 from their external sides (surfaces, parts).

The open load-bearing spatial tubular carriage frame 6 can be made, for example, in the form of ellipsoid (see FIG. 3, 4, 5) or parallelepiped (not shown), both closed (see FIGS. 3, 4, 5) and open type (not shown).

The load-bearing power platform-frame 11 for in-ring lifting propellers 3, 4 can be made of pipes that overlap, for example, form a cross. At the same time, the electric motors 7 of the lifting in-ring propellers 3 are installed on the end sections of the pipes.

In one embodiment of the aircraft, the running (pushing) propellers (rotors) 5 or RMG (FIG. 3, 4, 5) can be installed in the center (closer to the rear side of the aircraft) and/or on the sides of the aircraft (at the left and right sides of the aircraft) on one common load-bearing power platform (9, 10), and/or on different separate load-bearing power platforms.

In another embodiment, the open spatial tubular frames 6 are installed on the end sections of the frame 10 (in the embodiment of the aircraft, when the electric motors of the lifting propellers (rotors) 5 are fixed on the inner parts (surfaces) 12 of the upper 13 and lower 14 tubes of the frame 6).

In one of the embodiments of the aircraft, at the central part of the aircraft, closest to the rear side of the aircraft, only one pushing (running) propeller (rotor) 5 can be installed.

The number of pushing propellers (rotors) 5 (see FIG. 2) or pushing RMG (see FIG. 3, 4, 5) to the left and to the right, relative to the side of the aircraft, is the same and can be any.

The number of pushing propellers (5, 8) in the central part of the aircraft may be the same or different from the number of pushing propellers (5, 8) installed to the left and right of the aircraft side.

When, for example, three pushing propellers 5 are installed in the center, at the left and to the right of the aircraft, the pushing propellers 5 are located at the certain distance from each other, while the side pushing propellers 5 are equidistant from the central propeller 5.

The number of coaxial pairs of electric motors 7 of pushing propellers 8 within one carriage frame 6—screen on the left and right, relative to the side of the aircraft, is the same and can be any depending on its size and volume.

The number of coaxial pairs of electric motors 7 of the pushing propellers 8 within one carriage frame 6 of the central running RMG can be any depending on its size and volume and may differ from the number of coaxial pairs of electric motors 7 of the pushing propellers 8 inside one carriage frame 6 of the side running (pushing) RMG.

The number of the lifting in-ring propellers 3, 4 at the front and rear of the aircraft is the same and can be any.

The number of open spatial (tubular) load-bearing carriage frames with running pushing RMG within in can be any.

The aircraft known from the state of the art carry out the horizontal straight flight due to change in the pitch angle (the aircraft leans forward) (see FIG. 1). The angle changes by increasing the thrust on the rear propellers (2), thereby changing the angle of the aircraft and the thrust vector appears that moves the aircraft forward.

In the claimed aircraft for horizontal straight flight and vertical take-off/landing, it is not necessary to change the pitch angle, and the aircraft remains in the horizontal plane, thereby reducing drag and increasing the flight speed of the aircraft. This is achieved through the use of additional-auxiliary pushing propellers (rotors) 5 (see FIG. 2) or RMGs (see FIG. 3, 4, 5).

Since for horizontal straight movement, the resulting vertical and horizontal thrust of the rear propellers (2) is not used (see FIG. 1), and completely the thrust of additional auxiliary pushing propellers (rotors) 5 or the thrust of the additional pushing RMG (see FIG. 3, 4, 5), then the energy costs for horizontal straight flight are reduced.

Improved handling and maneuverability is achieved by changing the thrust on the additional auxiliary pushing propellers (ref. no. 5, FIG. 2) or the thrust of additional running (pushing) RMG (see FIG. 3, 4, 5): to turn to the left, the thrust of the right pushing propellers (rotor) 5 increases (see FIG. 2) or the thrust of the right RMG (see FIG. 3, 4, 5), and to turn to the right, the thrust of the left pushing propeller (rotor) 5 increases (see FIG. 2) or the thrust of the left RMG (see FIG. 3, 4, 5). Thus, there is the deviation of the aircraft on the course and the correction of the course.

Adjusting the rotation speed of the pushing propellers (rotors) (ref. no. 5 in FIG. 2 and ref no 8 in FIGS. 3, 4, 5) and/or lifting in-ring propellers (ref no. 3, 4 in FIG. 2), each individually or all together at the same time, with the help of independently operating electric motors 7, the aircraft can perform various actions (maneuvers) during flight, for example, turn, hover, and also achieve the certain balance to ensure stability and comfort of flight.

Increasing the safety of take-off/landing and flight of aircraft, and ensuring the protection of the pushing propellers (rotors) (5, 8) from collisions with the ground surface and other obstacles, are achieved due to the absence of open rotating blades of additional pushing propellers (5, 8). For this purpose, in the claimed invention, additional running (pushing) propellers (5, 8) are installed and fixed inside the open load-bearing spatial tubular carriage frames 6 in the form of ellipsoid or parallelepiped that perform the function of screens of the pushing propellers (rotors) 5. In addition, the front 3 and rear 4 lifting propellers, instead of open-blade rotors, are configured as in-ring propellers, with the blades being enclosed in a closed ring (casing).

The increased fail-safety while maintaining the position of the aircraft in flight and flight safety is achieved through the use of coaxial pairs of independently operating electric motors 7 of pushing propellers (rotors) 8 and groups of lifting in-ring propellers 3, 4 (due to duplication of the RMG of the aircraft).

An increase of the environmental friendliness of the aircraft is achieved through the use of electric motors 7, pushing propellers 8 and in-ring propellers 3, 4.

The electric motors 7 and the pushing propellers (rotors) (5, 8) are installed inside the open space carriage frame 6 in such a way that they are visible from all external sides and there is access to them. This permits a quick identification and elimination of various malfunctions (breakdowns) of electric motors 7 and pushing propellers (rotors) (5, 8), as well as their repair and replacement.

Increasing the compactness of the aircraft (reducing the area of the aircraft) is achieved by installing smaller pushing propellers (rotors) 8 inside the open load-bearing carriage frame 6 in the form of coaxial pairs instead of installing one separate propeller (rotor) 1, 2 of the larger size, as well as by installing smaller lifting front and rear 3, 4 in-ring propellers instead of larger bearing rotors (propellers) 1, 2.

The use of additional running (pushing) propellers (rotors) (ref. no. 5, FIG. 2) or additional running (pushing) RMG (see FIG. 3, 4, 5) provides for a significantly increase of the thrust and flight speed of the aircraft.

The aircraft described herein for the implementation of described flight method is compact, safe during take-off/landing and flight, and is made with the possibility of both horizontal straight-line flight and vertical take-off/landing, and has high maneuverability and controllability, as well as increased flight speed.

The analysis of the state of the art made it possible to establish: there are no analogs with the set of essential features that are identical and similar to the essential features of the group of inventions described herein, which indicates that the group of inventions described herein meets the “novelty” patentability condition. The results of the search for known solutions in order to identify essential features that coincide with the essential features of the group of inventions described herein that are distinctive from analogues showed that they do not explicitly follow from the state of the art, and the influence of the distinctive essential features on the technical results indicated by the authors has not been established. Therefore, the group of inventions described herein corresponds to the patentability condition “inventive level”.

Despite the fact that the above-described group of inventions is described with reference to its certain embodiments, it will be clear to specialists in this field of technology that various changes in the form and content of the group of inventions described herein can be made in it without deviation from the essence and scope of the inventions described herein, which are determined by the attached claims, taking into account the description and drawings.

1. A method of vertical take-off, landing and horizontal straight flight of an aircraft, the method comprising:
performing a vertical take-off or landing of the aircraft by activating a plurality of front lifting propellers and a plurality of rear lifting propellers, each of the front lifting propellers and the rear lifting propellers being an in-ring propeller that is mounted to a load-bearing carriage frame and is connected to a respective independently operating electric motor;
wherein the front lifting in-ring propellers and the rear lifting in-ring propellers are present in equal numbers;
wherein the front lifting in-ring propellers are positioned generally horizontally and symmetrically opposite to one another and equidistantly relative to the longitudinal axis of the aircraft; and
wherein the rear lifting in-ring propellers are positioned generally horizontally and symmetrically opposite to one another and equidistantly relative to the longitudinal axis of the aircraft;
carrying out a horizontal straight flight of the aircraft by activating at least one right pushing propeller and at least one left pushing propeller, each of the at least one right pushing propeller and the at least one left pushing propeller being connected to a respective independently operating electric motor;
wherein the at least one right pushing propeller and the at least one left pushing propeller are present in equal numbers; and
wherein the at least one right pushing propeller and the at least one left pushing propeller are positioned generally vertically and symmetrically opposite to one another and equidistantly relative to the longitudinal axis of the aircraft.

2. The method of claim 1, wherein the at least one right and left pushing propellers are positioned closer to a middle than to opposite ends of the at least one common load-bearing frame and closer to a rear of the aircraft than to a front of the aircraft.

3. The method of claim 2,
wherein the at least one right and left pushing propellers are positioned at a middle of the aircraft and on a right side and left side of the aircraft, respectively; and
wherein the at least one right and left pushing propellers are positioned on left and right sides of the aircraft and rotate about a horizontal axis parallel to the longitudinal axis of the aircraft.

4. The method of claim 1, wherein the independently operating electric motors of the at least one right and left pushing propellers are coupled to at least one common load-bearing frame oriented perpendicularly to the longitudinal axis of the aircraft, and wherein the at least one right and left pushing propellers are located on right and left sides of the aircraft, respectively, and rotate about a horizontal axis parallel to the longitudinal axis of the aircraft.

5. The method of claim 1, wherein the independently operating electric motors of the front and rear lifting in-ring propellers are mounted on an external load-bearing carriage frame, and wherein each of front lifting in-ring propellers and the rear lifting in-ring propellers rotates about a respective vertical axis.

6. The method of claim 5, wherein the independently operating electric motors of the at least one right and left pushing propellers include a coaxial pair of the independently operating electric motors, and wherein the coaxial pair of the electric motors of the at least one right and left pushing propellers are mounted on at least one common load-bearing frame, and wherein each of at least one right and left pushing propellers rotates about a respective horizontal axis and does not contact the external carriage frame during rotation about the respective horizontal axis.

7. The method of claim 5, wherein the independently operating electric motors of the front and rear lifting in-ring propellers include a plurality of coaxial independently operating electric motors, and wherein the coaxial independently operating electric motors of the front and rear lifting in-ring propellers mounted to an inner surface of the external carriage frame, and wherein each of at least one right and left pushing propellers rotates about a respective horizontal axis and does not contact the external carriage frame during rotation about the respective horizontal axis.

8. The method of claim 5, wherein the external carriage frame is tubular and in a form of a closed-end or open-end ellipsoid or parallelepiped.

9. The method of claim 1,
wherein the at least one right and left pushing propellers are present in equal total numbers on right and left sides of the aircraft, respectively; and
wherein the independently operating electric motors of the at least one right pushing propeller and the at least one left pushing propeller are located interiorly relative to an external carriage frame such that the independently operating electric motors of the at least one right and left pushing propeller are visible and accessible from all sides of the aircraft.

10. The method of claim 1, wherein the front and rear independently operating electric motors of the front and rear lifting in-ring propellers are present in equal total numbers at a front and rear of the aircraft, respectively.

11. An aircraft for vertical take-off, landing and horizontal straight flight, the aircraft comprising:
a plurality of front lifting propellers and a plurality of rear lifting propellers configured to facilitate a vertical take-off or landing of the aircraft when activated, each of the front lifting propellers and the rear lifting propellers being an in-ring propeller that is mounted to a load-bearing carriage frame and connected to a respective independently operating electric motor;
wherein the front in-ring lifting propellers and the rear lifting in-ring propellers are present in equal numbers;
wherein the front in-ring lifting propellers are positioned generally horizontally and symmetrically opposite to one another and equidistantly relative to the longitudinal axis of the aircraft; and
wherein the rear lifting in-ring propellers are positioned generally horizontally and symmetrically opposite to one another and equidistantly relative to the longitudinal axis of the aircraft; and
at least one right pushing propeller and at least one left pushing propeller configured to facilitate a horizontal straight flight of the aircraft when activated, each of the at least one right pushing propeller and the at least one left pushing propeller being connected to a respective independently operating electric motor;
wherein the at least one right pushing propeller and the at least one left pushing propeller are present in equal numbers; and
wherein the at least one right pushing propeller and the at least one left pushing propeller are positioned generally vertically and symmetrically opposite to one another and equidistantly relative to the longitudinal axis of the aircraft.

12. The aircraft of claim 11, wherein the at least one right and left pushing propellers are positioned closer to a middle than to opposite ends of the at least one common load-bearing frame and closer to a rear of the aircraft than to a front of the aircraft.

13. The aircraft of claim 12,
wherein the at least one right and left pushing propellers are positioned at a middle of the aircraft and on a right side and left side of the aircraft, respectively; and
wherein the at least one right and left pushing propellers are positioned on left and right sides of the aircraft and rotate about a horizontal axis parallel to the longitudinal axis of the aircraft.

14. The aircraft of claim 11, wherein the independently operating electric motors of the at least one right and left pushing propellers are coupled to at least one common load-bearing frame oriented perpendicularly to the longitudinal axis of the aircraft, and wherein the at least one right and left pushing propellers are located on right and left sides of the aircraft, respectively, and rotate about a horizontal axis parallel to the longitudinal axis of the aircraft.

15. The aircraft of claim 11, wherein the independently operating electric motors of the front and rear lifting in-ring propellers are mounted on an external load-bearing carriage frame, and wherein each of front lifting in-ring propellers and the rear lifting in-ring propellers rotates about a respective vertical axis.

16. The aircraft of claim 15, wherein the independently operating electric motors of the at least one right and left pushing propellers include a coaxial pair of the independently operating electric motors, and wherein the coaxial pair of the electric motors of the at least one right and left pushing propellers are mounted on at least one common load-bearing frame, and wherein each of at least one right and left pushing propellers rotates about a respective horizontal axis and does not contact the external carriage frame during rotation about the respective horizontal axis.

17. The aircraft of claim 15, wherein the independently operating electric motors of the front and rear lifting in-ring propellers include a plurality of coaxial independently operating electric motors, and wherein the coaxial independently operating electric motors of the front and rear lifting in-ring propellers mounted to an inner surface of the external carriage frame, and wherein each of at least one right and left pushing propellers rotates about a respective horizontal axis and does not contact the external carriage frame during rotation about the respective horizontal axis.

18. The aircraft of claim 15, wherein the external carriage frame is tubular and in a form of a closed-end or open-end ellipsoid or parallelepiped.

19. The aircraft of claim 11,
wherein the at least one right and left pushing propellers are present in equal total numbers on right and left sides of the aircraft, respectively; and
wherein the independently operating electric motors of the at least one right pushing propeller and the at least one left pushing propeller are located interiorly relative to an external carriage frame such that the independently operating electric motors of the at least one right and left pushing propeller are visible and accessible from all sides of the aircraft.

20. The aircraft of claim 11, wherein the front and rear independently operating electric motors of the front and rear lifting in-ring propellers are present in equal total numbers at a front and rear of the aircraft, respectively.
